(19) United States
(12) Patent Application Publication
(10) Pub. No.: US 2026/0319309 A1
(43) Pub. Date: Oct. 15, 2026

(54) ELECTROCHROMIC ELEMENT, LENS UNIT, AND IMAGING APPARATUS

(71) Applicant: CANON KABUSHIKI KAISHA, Tokyo (JP)

(72) Inventor: KAZUYA MIYAZAKI, Tokyo (JP)

(21) Appl. No.: 19/641,358

(22) Filed: Apr. 7, 2026

(30) Foreign Application Priority Data
Apr. 15, 2025 (JP) 2025-066837

(51) Int. Cl. G02F 1/155; G02F 1/1514

(52) U.S. Cl. CPC G02F 1/155; G02F 1/1514; G02F 2001/15145; G02F 2203/055

(57) ABSTRACT

As an electrochromic element capable of controlling transmittance that can sufficiently support use in a variable neutral density (ND) filter, an electrochromic element includes a first light modulating region and a second light modulating region that do not overlap with each other in orthogonal projection on a principal surface of an electrode substrate and that are driven by an identical voltage signal. The electrochromic element is configured to detect transmittance in the second light modulating region to control transmittance in the first light modulating region.

### BACKGROUND

### Field of the Technology

The present disclosure relates to an electrochromic element, a lens unit using the electrochromic element, and an imaging apparatus using the electrochromic element.

### Description of the Related Art

An electrochromic (may be hereinafter referred to as "EC") element is an element including a pair of electrodes and an EC layer disposed between the pair of electrodes, and is an optical element that applies voltage between the pair of electrodes to oxidize or reduce a compound in the EC layer, and thereby adjusts a color and quantity of light in a visible light region.

In recent years, the EC element has been put into practical use in an anti-glare mirror for an automobile, an airplane window, and the like, and there is also a growing demand for practical use of the EC element as a variable neutral density (ND) filter in a moving-image capturing apparatus. Since a degree of adjustment of a light quantity directly relates to exposure of an acquired image in the use of the variable ND filter, more strict control of transmittance is required.

Japanese Unexamined Patent Application Publication No. 2023-521868 describes an element including first and second regions, and a technique of detecting intensity of outside light with the second region to control transmittance in the first region.

However, since a configuration according to the above-mentioned related art relates to open loop control, there is a disadvantage that the configuration is easily influenced by an external factor such as temperature, and it is difficult to strictly control transmittance.

### SUMMARY

In consideration of the above-mentioned disadvantage, the present disclosure is directed to provision of an EC element that implements transmittance control that can sufficiently support the use in the variable ND filter, a lens unit using the EC element, and an imaging apparatus using the EC element.

According to an aspect of the present disclosure, an electrochromic element includes a first electrode substrate, a second electrode substrate, an electrochromic layer containing at least one electrochromic compound disposed between the first electrode substrate and the second electrode substrate, and a first light modulating region and a second light modulating region that do not overlap with each other in orthogonal projection on a principal surface of each of the first and second electrode substrates and that are driven by an identical voltage signal, wherein the electrochromic element is configured to detect transmittance in the second light modulating region to control transmittance in the first light modulating region.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are schematic views each illustrating an embodiment of an electrochromic element according to the present disclosure. FIG. 1A is a schematic plan view. FIG. 1B is a cross-sectional schematic view illustrating an A-A' position in FIG. 1A.

FIG. 2 is a schematic plan view illustrating another embodiment of the electrochromic element according to the present disclosure.

FIG. 3 is a graph illustrating an amount of a maximum decrease in peripheral light quantity with respect to a distance from the center of the electrochromic element.

FIG. 4 is a schematic plan view illustrating an n example of series resistance pattern provided to a second light modulating region in the electrochromic element according to the present disclosure.

FIG. 5 is a schematic diagram illustrating an example of a driving device for the electrochromic element.

FIGS. 6A and 6B are schematic diagrams each illustrating a configuration example of an imaging apparatus according to the present disclosure.

FIGS. 7A and 7B are charts according to a first embodiment of the present disclosure. FIG. 7A is a chart indicating voltage in each region. FIG. 7B is a chart indicating optical density in each region.

FIG. 8 is a chart indicating an optical density correlation between regions according to the first embodiment of the present disclosure.

FIGS. 9A and 9B are charts according to a second embodiment of the present disclosure. FIG. 9A is a chart indicating voltage in each region. FIG. 9B is a chart indicating optical density in each region.

FIG. 10 is a chart indicating an optical density correlation between regions according to the second embodiment of the present disclosure.

FIGS. 11A and 11B are charts according to a third embodiment of the present disclosure. FIG. 11A is a chart indicating voltage in each region. FIG. 11B is a chart indicating optical density in each region.

FIG. 12 is a chart indicating an optical density correlation between regions according to the third embodiment of the present disclosure.

FIGS. 13A and 13B are charts according to a comparative example 1 of the present disclosure. FIG. 13A is a chart indicating voltage in each region. FIG. 13B is a chart indicating optical density in each region.

FIG. 14 is a chart indicating an optical density correlation between regions according to the comparative example 1 of the present disclosure.

### DESCRIPTION OF THE EMBODIMENTS

An electrochromic (EC) element according to the present disclosure includes an EC layer between a first electrode substrate and a second electrode substrate, and the EC layer includes a first light modulating region and a second light modulating region that do not overlap with each other in orthogonal projection with respect to principal surfaces of the above-mentioned first and second electrode substrates. Then, the EC element is characterized by driving the first light modulating region and the second light modulating region with an identical voltage signal, detecting transmittance in the second light modulating region, and thereby controlling transmittance in the first light modulating region.

Embodiments regarding a configuration of the EC element according to the present disclosure will be exemplarily described in detail below with reference to drawings. However, configurations, relative arrangements, and the like described in the following embodiments are not intended to limit a scope of the present disclosure unless specifically described.

### EC Element

### Configuration of EC Element

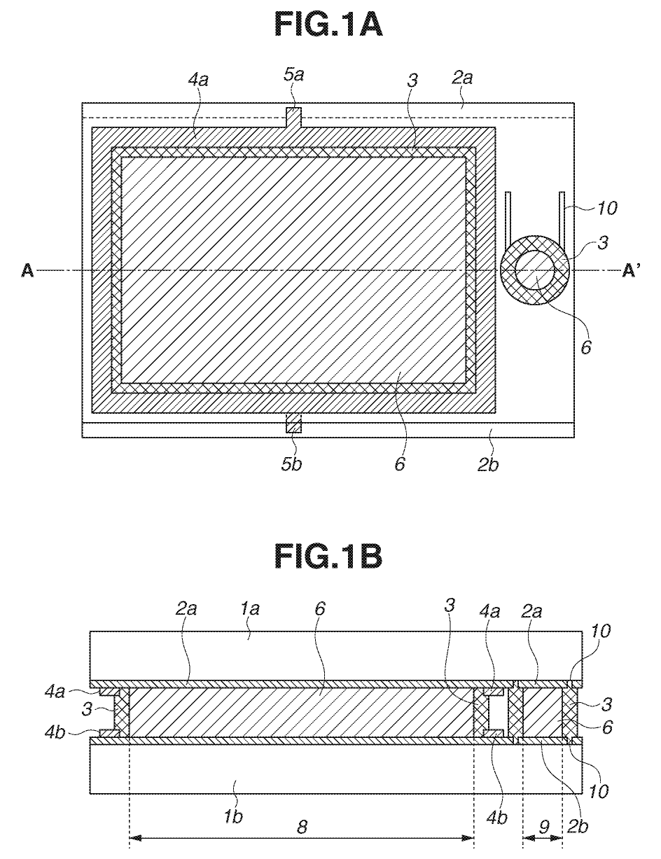

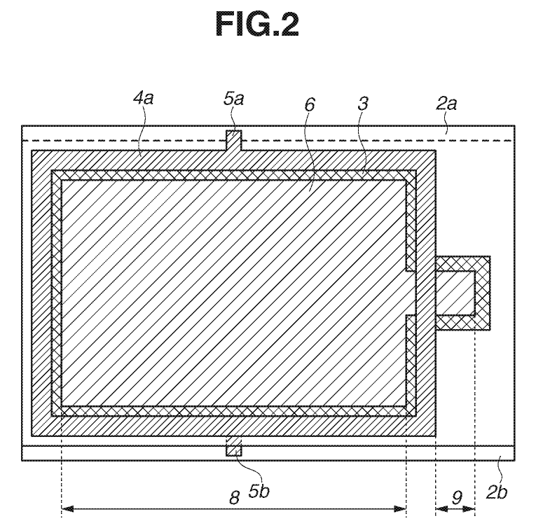

The configuration of the EC element according to the present disclosure will be described with reference to FIGS. 1A, 1B, and 2. FIGS. 1A and 1B are schematic views illustrating an embodiment of the EC element according to the present disclosure. FIG. 1A is a schematic plan view illustrating main components. FIG. 1B is a cross-sectional schematic view illustrating an A-A' position in FIG. 1A. The EC element is configured to include a pair of substrates. It is favorable that a transparent electrode and a bus-bar electrode (bus wiring) have identical shapes and identical configurations as a pair of substrates.

In FIGS. 1A, 1B, and 2, there are a first substrate 1a, a second substrate 1b, a first transparent electrode 2a on the first substrate 1a, and a second transparent electrode 2b on the second substrate 1b.

The first substrate 1a and the first transparent electrode 2a constitute a first electrode substrate, and the second substrate 1b and the second transparent electrode 2b constitute a second electrode substrate. There are a sealing 3, a bus-bar electrode 4a formed on the first transparent electrode 2a on the first substrate 1a, and a bus-bar electrode 4b formed on the transparent electrode 2b on the second substrate 1b. A power supply unit 5a is a power supply unit in the bus-bar electrode 4a. A power supply unit 5b is a power supply unit in the bus-bar electrode 4b. An EC layer 6 is sandwiched and held by the first transparent electrode 2a on the first substrate 1a and the transparent electrode 2b on the second substrate 1b. A cutout pattern 10 is a cutout pattern of the first transparent electrode 2a and the second transparent electrode 2b. An EC element 7 is composed of a first light modulating region 8 and a second light modulating region 9. An identical voltage signal is applied to the first light modulating region 8 and the second light modulating region 9 from an identical terminal, whereby the first light modulating region 8 and the second light modulating region 9 are simultaneously driven.

Each of the first substrate 1a and the second substrate 1b is a transparent substrate, and is required to have an electrical insulating property, high transparency, excellent heat resistance, and high chemical stability, such as glass or resin. As glass, it is possible to use optical glass, quartz glass, white plate glass, soda-lime glass, borosilicate glass, alkali-free glass, chemically strengthened glass, or the like. It is possible to favorably use alkali-free glass, in particular, in terms of transparency and durability. As resin, it is possible to use polycarbonate (PC), acrylic resin such as polymethylmethacrylate (PMMA), polyethylene terephthalate (PET), transparent polyimide (PI) or the like. Additionally, it is possible to favorably use resin of these kinds in which a hard coating layer is formed on its surface to increase abrasion-resistance.

Examples of the first transparent electrode 2a and the second transparent electrode 2b can include an indium tin oxide (ITO) alloy, fluorine-doped tin oxide (FTO), tin oxide (NESA), indium zinc oxide (IZO), and graphene. Additionally, favorably useable are electrically conductive polymers whose electrical conductivity has been increased by doping treatment or the like, such as, polyaniline, polypyrrole, polythiophene, polyacetylene, polyparaphenylene, and a complex of poly(3,4-ethylenedioxythiophene) (PEDOT) and polystyrene sulfonate.

The sealing 3 connects the first substrate 1a on which the first transparent electrode 2a is formed and the second substrate 1b on which the second transparent electrode 2b is formed, and favorably has a function of protecting the EC layer 6 from oxygen and water. The EC layer 6 will be described below. Additionally, since the sealing 3 is in direct contact with the EC layer 6, which is electrochemically active, it is required to be unreactive to an EC compound, and have a low affinity to a solvent that dissolves the EC compound. As the sealing 3, it is possible to favorably use one-component solvent-free acrylic resin, epoxy resin, or the like. For the sealing 3, a single material may be used, or a plurality of materials with separated functions may be used as a multi-layered and multi-structured configuration. Additionally, the sealing 3 may have a spacer that defines a distance between the first transparent electrode 2a and the second transparent electrode 2b. The spacer may be composed of an inorganic material such as silica beads or glass fiber, or an organic material such as polydivinylbenzene, polyimide, polytetrafluoroethylene, fluorine-containing rubber, or epoxy resin.

The bus-bar electrodes 4a and 4b are installed outside the sealing 3, as wiring to guarantee application of uniform voltage in the first light modulating region 8. The bus-bar electrodes 4a and 4b are favorably made of a metallic material with low resistance. For example, it is possible to use a thin film or the like made of silver, palladium, copper, aluminum, a silver-palladium-copper alloy (APC), or an aluminum-neodymium alloy. It is favorable that the bus-bar electrodes 4a and 4b be formed on the EC layer 6 side of the paired first and second transparent electrodes 2a and 2b, respectively, so as to surround the first light modulating region 8. Alternatively, the plurality of power supply units 5a and 5b may be installed in each of the bus-bar electrodes 4a and 4b to prevent a voltage drop in the bus-bar electrodes 4a and 4b.

The EC layer 6 in the first light modulating region 8 and that in the second light modulating region 9 have identical compositions. The EC layer 6 is favorably an organic solvent in which an electrochromic compound (EC compound) is dissolved. The EC compound is favorably an organic compound (organic EC compound), and may be an anodic compound that is colored from a light transmitting state by oxidation reaction, or a cathodic compound that is colored from the light transmitting state by reduction reaction. Alternatively, both the anodic compound and the cathodic compound may be used. Using the anodic compound and the cathodic compound together increases coloration efficiency with respect to current and thus is favorable. In the present specification, an element containing both the anodic compound and the cathodic compound is referred to as a complementary EC element. The anodic compound is also referred to as an anode material, and the cathodic compound is also referred to as a cathode material.

In a case where the complementary EC element is driven, electrons are extracted from the EC compound by oxidation reaction in one electrode, and the EC compound receives electrons by reduction reaction in the other electrode. A radical cation may be generated from a neutral molecule by oxidation reaction. Additionally, a radical anion may be generated from a neutral molecule by reduction reaction, or a radical cation may be generated from a dication molecule. The EC compound is colored in each of the paired first and second transparent electrodes 2a and 2b. Thus, in a case where a large change in optical density is necessary at the time of coloring, it is favorable to employ the complementary EC element.

Examples of the organic EC compound include electrically conductive polymers such as polythiophene and polyaniline, and organic low molecular compounds such as a viologen-based compound, an anthraquinone-based compound, an oligothiophene derivative, and a phenazine derivative.

It is favorable that the EC layer 6 contain at least one kind of an anodic EC compound or a cathodic EC compound to constitute the complementary EC element.

In a case where the EC layer 6 contains a plurality of kinds of EC compounds, it is favorable that the EC compounds have a small difference in oxidation-reduction potential. In a case of containing the plurality of kinds of EC compounds, the EC layer 6 may contain four or more kinds of EC compounds including anode compounds and cathode compounds. The EC element according to the present disclosure may contain five or more kinds of EC compounds. In a case where the EC element contains a plurality of kinds of EC compounds, it is favorable that a plurality of anode materials be at an oxidation-reduction potential of 60 mV or less, and a plurality of cathode materials be at an oxidation-reduction potential of 60 mV or less. In a case of containing the plurality of kinds of EC compounds, it is favorable that the EC element contain a compound having an absorption peak from 400 nm to 500 nm, a compound having an absorption peak from 500 nm to 650 nm, and a compound having an absorption peak of 650 nm or more. The absorption peak mentioned herein indicates an absorption peak with a full width at half maximum of 20 nm or more. Additionally, a state of a material when absorbing light may be an oxidation state, a reduction state, or a neutral state.

The EC layer 6 may contain an electrolyte. The electrolyte is not limited as long as it is ion-dissociable salt and exhibits excellent solubility in a solvent. In a case of the solid electrolyte, it is not limited as long as it exhibits high compatibility. Among electrolytes, an electrolyte having an electron-donating property is favorable. These electrolytes can also be called supporting electrolytes. Examples of the electrolyte include inorganic ionic salts, such as various alkali metal salts and alkali earth metal salts, quaternary ammonium salts, and cyclic quaternary ammonium salts. Specific examples of the electrolyte include lithium, sodium, and potassium salts such as LiClO₄, LiSCN, LiBF₄, LiAsF6, LiCF₃SO₃, LiPF₆, LiI, NaI, NaSCN, NaClO₄, NaBF₄, NaAsF₆, KSCN, or KCl, and quaternary ammonium salts and cyclic quaternary ammonium salts such as (CH₃)₄NBF₄, (C₂H₅)₄NBF₄, (n-C₄H₉)₄NBF₄, (n-C₄H₉)₄NPF₆, (n-C₄H₉)₄NBr, (C₂H₅)₄NBr, (C₂H₅)₄NClO₄, and (n-C₄H₉)₄NClO₄.

A solvent that dissolves the EC compound and the electrolyte is not specifically limited as long as it can dissolve the EC compound and the electrolyte, but a solvent with a polarity is particularly favorable. Specific examples of the solvent include water and polar organic solvents such as methanol, ethanol, propylene carbonate, ethylene carbonate, dimethylsulfoxide, dimethoxyethane, γ-butyrolactone, γ-valerolactone, sulfolane, dimethylformamide, dimethoxyethane, tetrahydrofuran, acetonitrile, propionitrile, 3-methoxypropionitrile, benzonitrile, dimethylacetamide, methylpyrrolidinone, and dioxolane.

Additionally, the EC layer 6 may have a spacer that defines a distance between the first transparent electrode 2a and the second transparent electrode 2b. The spacer may be composed of an inorganic material such as silica beads or glass fiber, or an organic material such as polydivinylbenzene, polyimide, polytetrafluoroethylene, fluororubber, or epoxy resin.

The EC element 7 includes the first light modulating region 8 and the second light modulating region 9 within an identical surface. The first light modulating region 8 and the second light modulating region 9 may be completely separated from each other by the sealing 3 as illustrated in FIGS. 1A and 1B, or may be formed by one body of the sealing 3 as illustrated in FIG. 2. In the configuration illustrated in FIG. 2, the EC layer 6 in the first light modulating region 8 and the EC layer 6 in the second light modulating region 9 are a continuous body, which reduces a difference in characteristics between the first light modulating region 8 and the second light modulating region 9.

Here, a consideration is given to a density distribution on a surface in a light modulating region with a focus only on the first light modulating region 8.

Since the EC element 7 exhibits relatively large element current, a somewhat large voltage drop occurs in a surface electrode. Since the bus-bar electrodes 4a and 4b are formed to surround the outer periphery of the EC element 7, a potential becomes higher on the outer side of the EC element 7 and becomes the lowest at the center of the EC element 7. Thus, when voltage is applied to the EC element 7 to color the EC element 7, the EC element 7 exhibits a density distribution in which the density is the lowest (transmittance is the highest) at a center portion and becomes higher (transmittance becomes lower) toward the periphery.

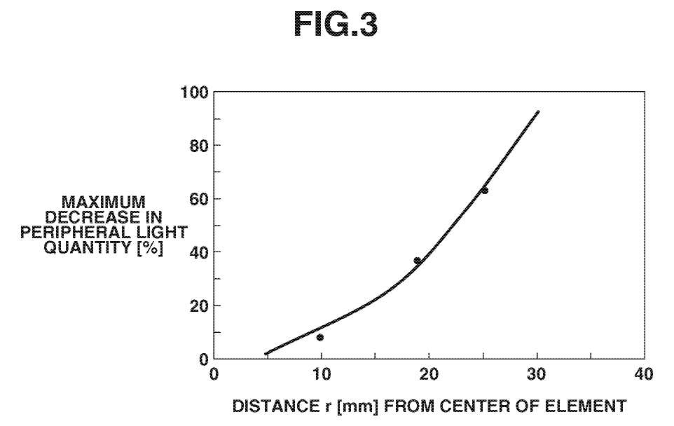

FIG. 3 illustrates an amount of a maximum decrease in peripheral light quantity with respect to a distance from the center of the EC element 7 (element size) (a ratio [%] of a difference in transmittance in the periphery to transmittance at the center of the EC element 7). Here, sheet resistance in each of the first transparent electrode 2a and the second transparent electrode 2b is 5.9 Ω/□. Since an amount of a decrease in peripheral light quantity depends on current and voltage characteristics and transmittance and voltage characteristics of the EC element 7, attention should be paid to voltage dependence. That is, when voltage and current are small and thus a voltage drop is small, the decrease in peripheral light quantity becomes small. Additionally, when voltage and current are large and thus a voltage drop is large and in a case where each of current and transmittance approaches a saturation value at this time, the decrease in peripheral light quantity becomes similarly small. Thus, the decrease in peripheral light quantity becomes maximum when voltage is in a medium level. In a case where the distance from the center of the EC element 7 exceeds 14 mm (a diagonal distance of the EC element 7 is 28 mm), the maximum decrease in peripheral light quantity exceeds 20% and the decrease in peripheral light quantity becomes noticeable. Furthermore, in a case where the distance from the center of the EC element 7 exceeds 22 mm (a diagonal distance of the EC element 7 is 44 mm), the maximum decrease in peripheral light quantity exceeds 50%, and it becomes extremely difficult to use the EC element 7 in consideration of a decrease in peripheral light quantity of a lens.

That is, since the decrease in peripheral light quantity becomes noticeable in a case where the diagonal distance of the EC element 7 exceeds 28 mm, it becomes difficult to prepare a larger light modulating region and feed back a transmittance measurement value at the edge portion of the light modulating region. Here, it is assumed that sheet resistance in each of the first transparent electrode 2a and the second transparent electrode 2b is 5.9 Ω/□. However, if the sheet resistance decreases to 2.0 Ω/□, the distance to exhibit the maximum decrease in peripheral light quantity of 20% is approximately 20 mm (the diagonal distance of the EC element 7 is 40 mm), the distance to exhibit the maximum decrease in peripheral light quantity of 50% is approximately 31 mm (the diagonal distance of the EC element 7 is 62 mm), and furthermore, a film thickness of each of the first transparent electrode 2a and the second transparent electrode 2b becomes large, resulting in a significant decrease in transmittance of the EC element 7 to approximately 70%. Hence, in the EC element 7 with such a size that the distance from the center of the EC element 7 exceeds 22 mm (the diagonal distance of the EC element is 44 mm), it becomes difficult to employ a configuration of measuring transmittance in the first light modulating region 8.

Thus, it is necessary to prepare the second light modulating region 9 whose transmittance simulates average transmittance in the first light modulating region 8 and a transmittance detection unit to detect the transmittance in the second light modulating region 9, and employ a configuration of estimating transmittance in the first light modulating region 8 from the measured transmittance value of the second light modulating region 9.

In the second light modulating region 9, it is possible to favorably measure the transmittance by using a light-emitting element and a light-receiving element. It is possible to estimate the transmittance in the first light modulating region 8 from the transmittance measured in the second light modulating region 9, and it is possible to use this measured value to control a waveform of voltage for driving the first light modulating region 8 and the second light modulating region 9 or estimate spectral characteristics in the first light modulating region 8. It is favorable that a size of the second light modulating region 9 be set to be as small as possible based on a size of the light-emitting element and that of the light-receiving element. That is, to suppress current flowing in the second light modulating region 9 and prevent occurrence of a transmittance distribution, it is favorable that the diagonal distance in the second light modulating region 9 be 28 mm or less while the diagonal distance in the first light modulating region 8 exceeds 28 mm.

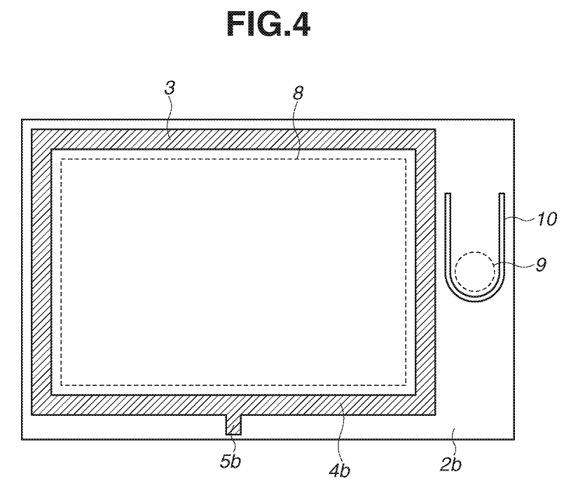

Additionally, to simulate the transmittance in the first light modulating region 8, it is favorable to provide the second light modulating region 9 with series resistance formed by patterning of the first transparent electrode 2a and the second transparent electrode 2b. FIG. 4 is a schematic plan view exemplifying a series resistance pattern provided to the second light modulating region 9, and is a schematic view when the second transparent electrode 2b is viewed from the EC layer 6 side. The cutout pattern 10 is a cutout pattern of the transparent electrode 2b, and it is possible to determine its length and shape, that is, a magnitude of series resistance as appropriate depending on at which part of the first light modulating region 8 a target setting value is set. The first light modulating region 8 has a transmittance distribution in which transmittance decreases toward the periphery. The cutout pattern 10 is formed also in the first transparent electrode 2a.

In the present disclosure, it is favorable that an average potential in the second light modulating region 9 be within ±2% of an average potential in the first light modulating region 8.

### Use of EC Element

An EC element according to the present disclosure can be used in an optical filter, a lens unit, an imaging apparatus, or the like.

### Optical Filter

An optical filter according to the present embodiment includes an EC element and an active element connected to the EC element. The active element is an element that drives the EC element and adjusts a light quantity of light that passes through the EC element. Examples of the active element include a transistor. The transistor may include an oxide semiconductor such as InGaZnO in an active region.

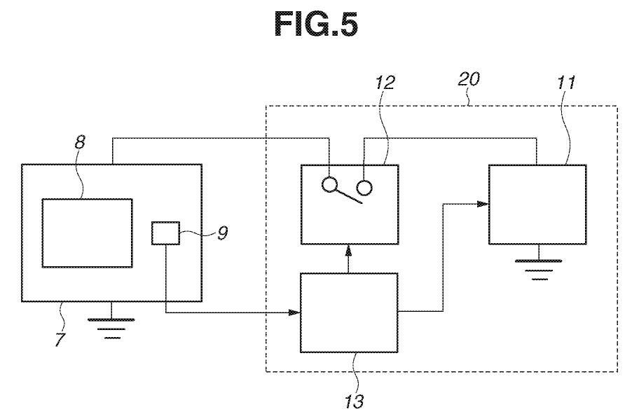

Additionally, examples of a configuration of the optical filter include a configuration including the EC element according to the present disclosure and a driving device connected to the EC element. FIG. 5 is a schematic diagram illustrating an example of a driving device 20 for an EC element and the EC element 7 driven by the driving device 20. The driving device 20 according to the present embodiment includes a driving source 11, a resistor switch 12, and a controller 13.

The driving source 11 applies voltage necessary for an EC material contained in the EC layer to cause electrochemical reaction to the EC element 7. It is more favorable that the driving voltage be a fixed voltage. The fixed voltage is favorable because, in a case where the EC material is composed of a plurality of kinds of materials, an absorption spectrum may change due to a difference in oxidation-reduction potential and a difference in molar absorption coefficient between the materials. The start of application of voltage by the driving source 11 or holding of an application state is based on a signal from the controller 13. In control of transmittance in the first light modulating region 8 in the EC element 7, a driving condition is changed as needed so that a transmittance setting value and transmittance in the second light modulating region 9 in the EC element 7 are compared and the transmittance is approximated to the setting value. Examples of a parameter can include voltage, current, and a duty ratio, but it is possible to favorably use the duty ratio.

### Lens Unit

A lens unit according to the present embodiment includes an imaging optical system including a plurality of lenses, and an optical filter that controls a light quantity of light that has passed through the imaging optical system. The optical filter is an optical filter using the EC element according to the present disclosure. The optical filter may be provided between the plurality of lenses or outside the lenses. It is favorable that a first light modulating region in the optical filter be provided on an optical axis of the lenses. Additionally, it is favorable that a second light modulating region be provided outside effective rays and so as to prevent light leakage.

### Imaging Apparatus

The imaging apparatus according to the present embodiment includes an optical filter composed of the EC element according to the present disclosure and a light-receiving element that receives light that has passed through the optical filter. Specific examples of the imaging apparatus include a camera, a video camera, and a mobile phone with a camera. The imaging apparatus may be in a mode in which a main body including the light-receiving element and a lens unit including a lens can be separated from each other. In a case where the main body of the imaging apparatus and the lens unit can be separated from each other, a mode using an optical filter provided separately from the imaging apparatus at the time of imaging is included in the present disclosure. In this case, examples of an arrangement position of the optical filter include the outside of the lens unit, between the lens unit and the light-receiving element, and between a plurality of lenses (in a case where the lens unit includes the plurality of lenses).

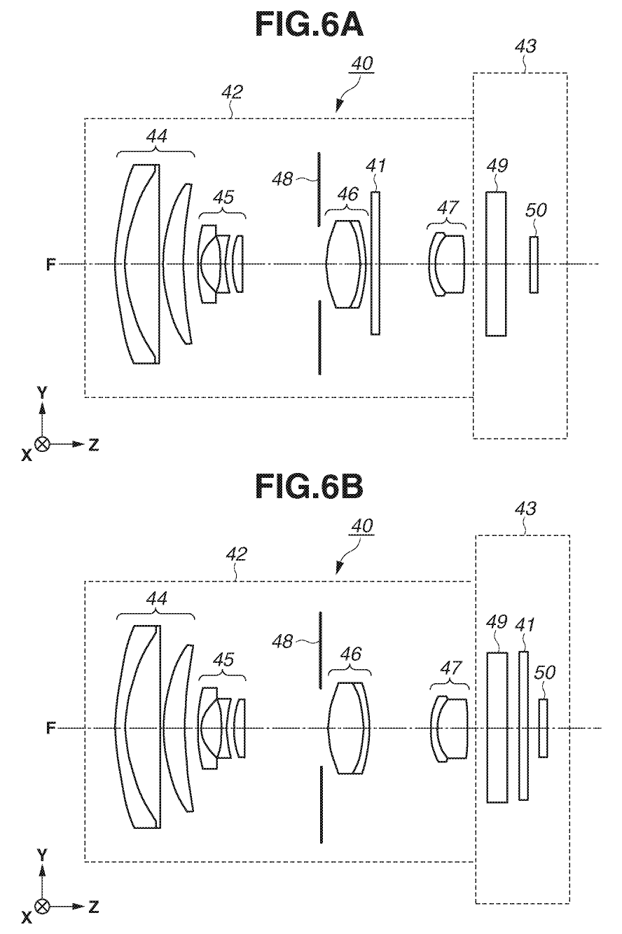

FIG. 6A is a schematic diagram illustrating an example of the imaging apparatus in which the optical filter is disposed in the lens unit. FIG. 6B is a schematic diagram illustrating an example of the imaging apparatus in which the optical filter is disposed in the imaging apparatus.

An imaging apparatus 40 includes a lens unit 42 and an imaging unit 43. The lens unit 42 includes an optical filter 41 and an imaging optical system including a plurality of lenses or a lens unit. The optical filter 41 is the above-mentioned optical filter according to the present embodiment.

The lens unit 42 represents, for example, a rear-focus system zoom lens that performs focusing behind an aperture stop in FIG. 6A. The lens unit 42 includes four lens units composed of, in the order from the object side, a first lens unit 44 having positive refractive power, a second lens unit 45 having negative refractive power, a third lens unit 46 having positive refractive power, and a fourth lens unit 47 having positive refractive power. The lens unit 42 changes an interval between the second lens unit 45 and the third lens unit 46 to change the zoom magnification, and moves part of the fourth lens unit 47 to perform focusing.

The lens unit 42 includes, for example, an aperture stop 48 between the second lens unit 45 and the third lens unit 46, and the optical filter 41 between the third lens unit 46 and the fourth lens unit 47. The lens unit 42 is disposed so that light in the lens unit 42 passes through the first lens unit 44 to the fourth lens unit 47, the aperture stop 48, and the optical filter 41, and is capable of adjusting a light quantity using the aperture stop 48 and the optical filter 41. The lens unit 42 is detachably connected to the imaging unit 43 via a mount member (not illustrated).

In the present embodiment, the optical filter 41 is disposed between the third lens unit 46 and the fourth lens unit 47 in the lens unit 42, but the imaging apparatus 40 is not limited to this configuration. For example, the optical filter 41 may be disposed before the aperture stop 48 (on the subject side) or behind the aperture stop 48 (on the imaging unit 43 side), or before or behind any one of the first lens unit 44 to the fourth lens unit 47, or between the lens units. If the optical filter 41 is disposed at a position where light converges, there is an advantage such as reduction of the area of the optical filter 41.

Additionally, a configuration of the lens unit 42 is also not limited to the above-mentioned configuration, and can be selected as appropriate. For example, the lens unit 42 may employ, other than the rear-focus system, an inner-focus system that performs focusing before the aperture stop 48, or another system. Additionally, other than a zoom lens, a special lens such as a fish-eye lens or a micro lens can be selected as appropriate.

The imaging unit 43 includes a glass block 49 and a light-receiving element 50. The glass block 49 is a glass block such as a law-pass filter, a face plate, or a color filter. Additionally, the light-receiving element 50 is a sensor unit that receives light having passed through the lens unit 42, and it is possible to use an image pickup element such as a charge-coupled device (CCD) or a complementary metal-oxide semiconductor (CMOS) sensor. Alternatively, the light-receiving element 50 may be an optical sensor such as a photodiode, and an optical sensor that acquires and outputs light intensity information or wavelength information can be used as appropriate.

In a case where the optical filter 41 is built into the lens unit 42 as illustrated in FIG. 6A, the driving device may be disposed in the lens unit 42 or outside the lens unit 42. In a case where the driving device is disposed outside the lens unit 42, the EC element in the lens unit 42 and the driving device are connected to each other through wiring and the driving device performs driving control.

Additionally, in the above-mentioned configuration of the imaging apparatus 40, the optical filter 41 is disposed inside the lens unit 42. However, the present disclosure is not limited to this mode, and it is sufficient if the optical filter 41 is disposed at a freely selected location inside the imaging apparatus 40 and the light-receiving element 50 is disposed so as to receive light that has passed through the optical filter 41.

For example, as illustrated in FIG. 6B, the imaging unit 43 may include the optical filter 41. FIG. 6B is a diagram for describing another configuration example of the imaging apparatus according to the present embodiment, and is a schematic diagram illustrating the imaging apparatus in which the optical filter 41 is included in the imaging unit 43. In FIG. 6B, for example, the optical filter 41 is disposed immediately before the light-receiving element 50.

In a case where the optical filter 41 is built into the imaging apparatus itself, the connected lens unit 42 itself may not include the optical filter 41, which makes it possible to configure the imaging apparatus capable of modulating light with use of the existing lens unit 42.

The imaging apparatus 40 according to the present embodiment is applicable to a product having a combination of adjustment of a light quantity and a light-receiving element. For example, the imaging apparatus 40 can be used in a camera, a digital camera, a video camera, and a digital video camera. Additionally, the imaging apparatus 40 is applicable also to a product that has a built-in imaging apparatus, such as a mobile phone, a smartphone, a personal computer (PC) or a tablet.

The imaging apparatus 40 according to the present embodiment uses the optical filter 41 as a light-modulating member, and can thereby change an amount of light modulation with one filter, which is advantageous in terms of reduction in the number of members and space-saving.

### Embodiments

### First Embodiment

In a first embodiment, an indium tin oxide (ITO) electrode with sheet resistance of 5.9 Ω/□ was used as a transparent electrode. First and second light modulating regions had rectangular shapes, and diagonal distances in the first and second light modulating regions were 50.3 mm and 3.3 mm, respectively.

Additionally, an Ag-Pd-Cu (APC) electrode with sheet resistance of 50 mΩ/□ was used as a bus-bar electrode. Terminal portions of the bus-bar electrode formed on each of the first and second electrode substrates were formed at two corners on the longitudinal side, and power was supplied from the terminal portions. Additionally, a substantially U-shaped cutout pattern surrounding the second light modulating region was formed in the first and second electrodes as illustrated in FIG. 4. This series resistance portion had a width of 2.3 mm, and a length (a distance from the end of the second light modulating region to a base portion of the cutout pattern in a current direction) of 13.8 mm.

An average value of voltage and an average value of optical density (OD value) in a mesh element were obtained in each of the first and second light modulating regions.

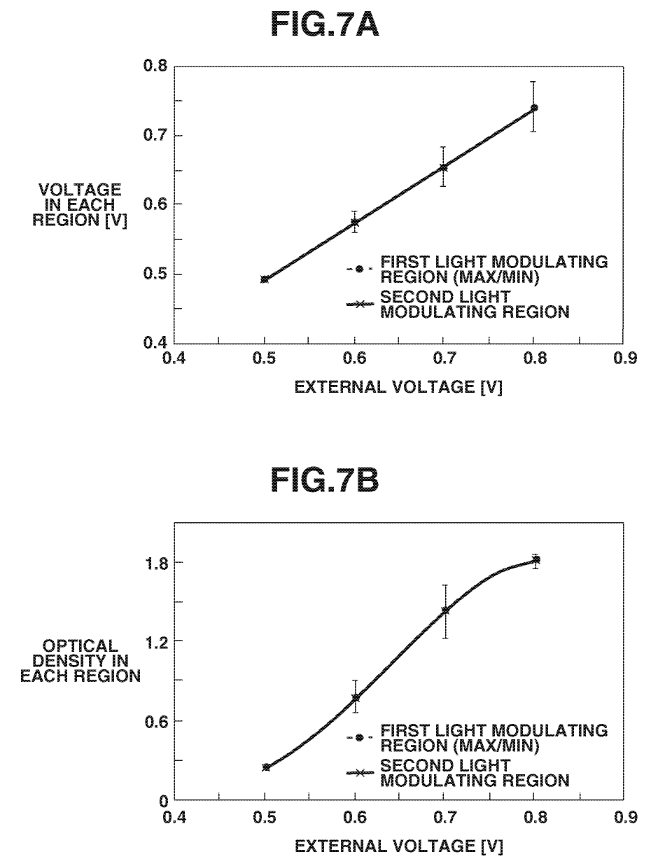

FIG. 7A is a chart on which average voltage in each of the first and second light modulating regions is plotted with respect to external voltage. A variation in potential in the first light modulating region increases with an increase of external voltage. The variation was 9.6% when the external voltage was 0.8 V. Meanwhile, since an average potential in the first light modulating region and an average potential in the second light modulating region were matched well, the difference was merely below 0.1%.

FIG. 7B is a chart on which average optical density in each of the first and second light modulating regions is plotted with respect to external voltage. A variation in optical density in the first light modulating region was the largest to be 34% at around 0.65 V. Meanwhile, since average optical density in the first light modulating region and average optical density in the second light modulating region were matched well, the difference was merely below 0.6%.

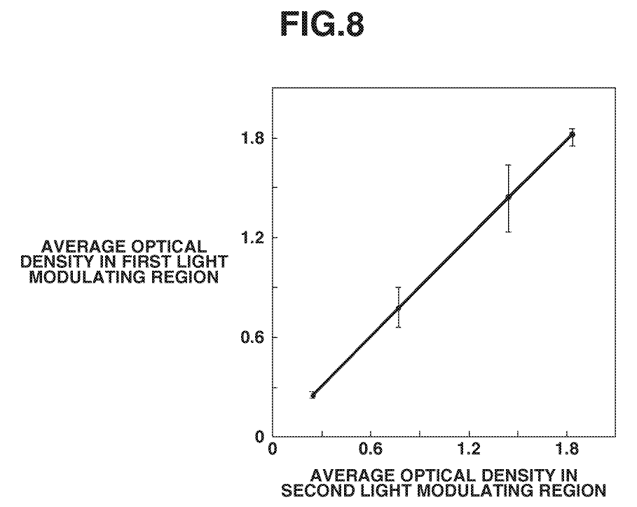

FIG. 8 illustrates a correlation between average optical density in the first light modulating region and average optical density in the second light modulating region, and it can be said that the average optical density in the first light modulating region and the average optical density in the second light modulating region are substantially matched in an unbiased manner in a range of 0 to 1.8 (equivalent to 0 to 6 stops).

### Second Embodiment

An EC element was produced so that, except that an ITO electrode with sheet resistance of 3.1 Ω/□ was used as a transparent electrode, the shape of the EC element and other parameters were similar to those in the first embodiment.

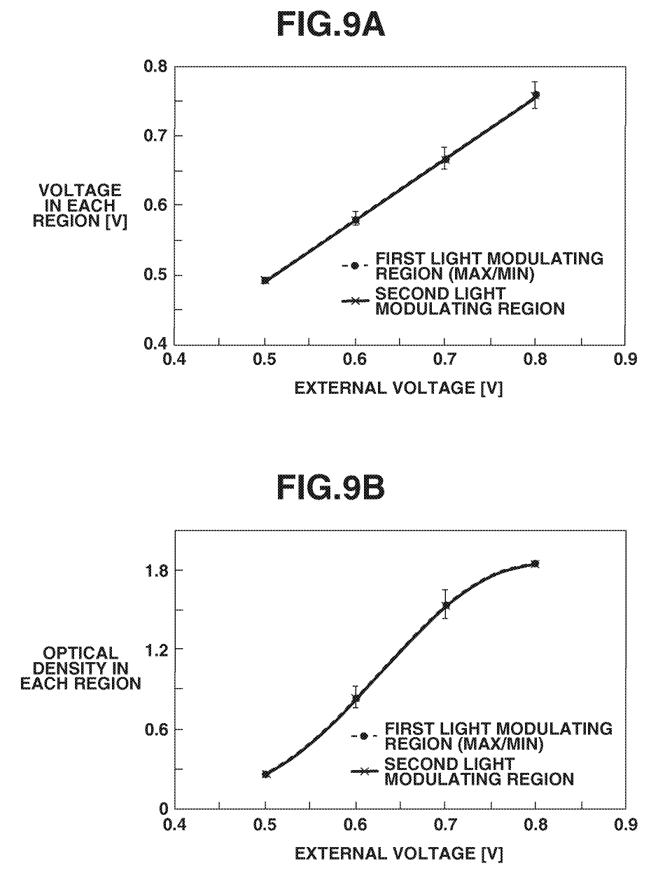

FIG. 9A is a chart on which average voltage in each of the first and second light modulating regions is plotted with respect to external voltage. Since resistance in the transparent electrode was about half resistance in the first embodiment, a voltage drop also became small, and a variation in potential in the first light modulating region was 5.4% when external voltage was 0.8 V.

Meanwhile, since an average potential in the first light modulating region and an average potential in the second light modulating region were matched well, the difference was merely below 0.3%.

FIG. 9B is a chart on which average optical density in each of the first and second light modulating regions is plotted with respect to external voltage. A variation in optical density in the first light modulating region was the largest to be 20% at around 0.6V. Meanwhile, since average optical density in the first light modulating region and average optical density in the second light modulating region were matched well, the difference was merely below 1.0%.

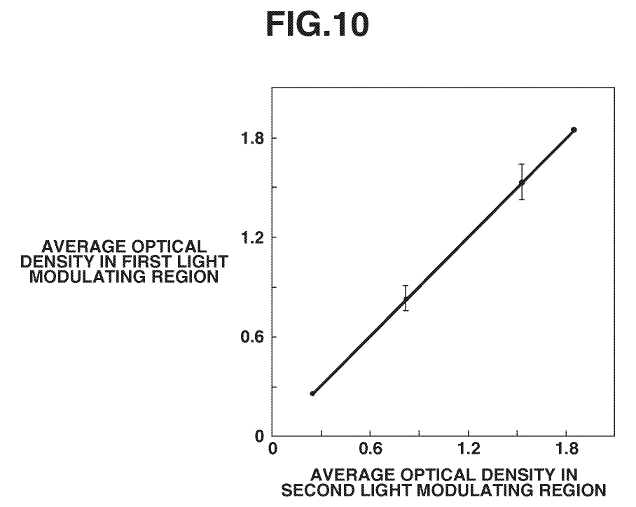

FIG. 10 illustrates a correlation between average optical density in the first light modulating region and average optical density in the second light modulating region, and it can be said that the average optical density in the first light modulating region and the average optical density in the second light modulating region are substantially matched in an unbiased manner in a range of 0 to 1.8 (equivalent to 0 to 6 stops).

### Third Embodiment

An EC element was produced so that, except that a terminal of a bus-bar electrode formed in each of the first and second electrode substrates was provided only in one location at the center of a long side and power was supplied from the terminal, the shape of the EC element and other parameters were similar to those in the first embodiment.

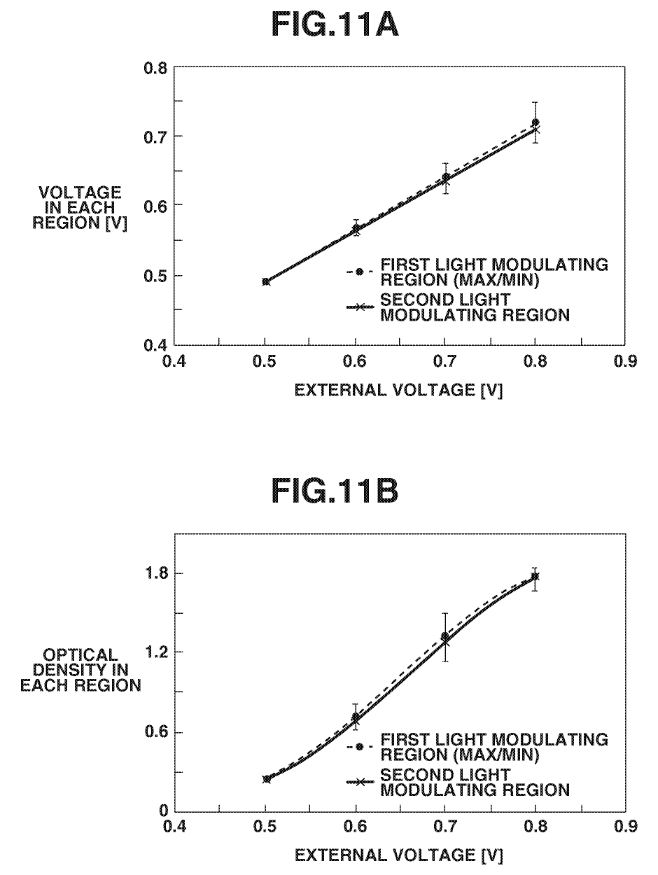

FIG. 11A is a chart on which average voltage in each of the first and second light modulating regions is plotted with respect to external voltage. Since a voltage drop in the bus-bar electrode was larger than a voltage drop in the first embodiment, a variation in potential in the first light modulating region was 8.4% when external voltage was 0.8 V. Meanwhile, since an average potential in the first light modulating region and an average potential in the second light modulating region were substantially matched, the difference was approximately 1.0%.

FIG. 11B is a chart on which average optical density in each of the first and second light modulating regions is plotted with respect to external voltage. A variation in optical density in the first light modulating region was the largest to be 30% at around 0.65 V. Meanwhile, since average optical density in the first light modulating region and average optical density in the second light modulating region were substantially matched, the difference was approximately 3.5%.

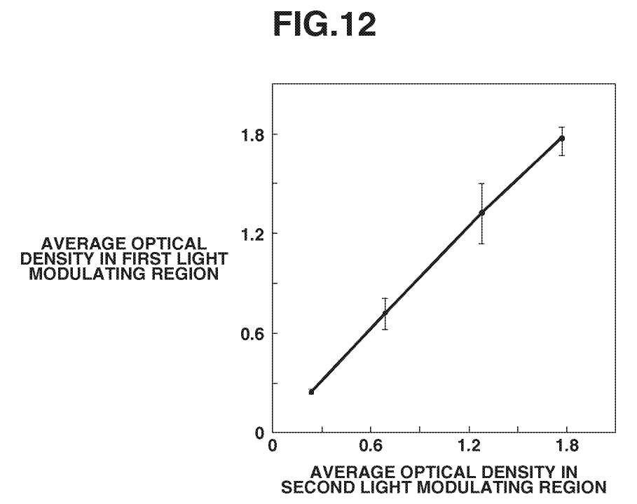

FIG. 12 illustrates a correlation between average optical density in the first light modulating region and average optical density in the second light modulating region, and it can be said that the average optical density in the first light modulating region and the average optical density in the second light modulating region are substantially matched in an unbiased manner in a range of 0 to 1.8 (equivalent to 0 to 6 stops).

### Comparative Example 1

An EC element was produced so that, except that the substantially U-shaped cutout pattern surrounding the second light modulating region as illustrated in FIG. 4 was not formed, the shape of the EC element and other parameters were similar to those in the first embodiment.

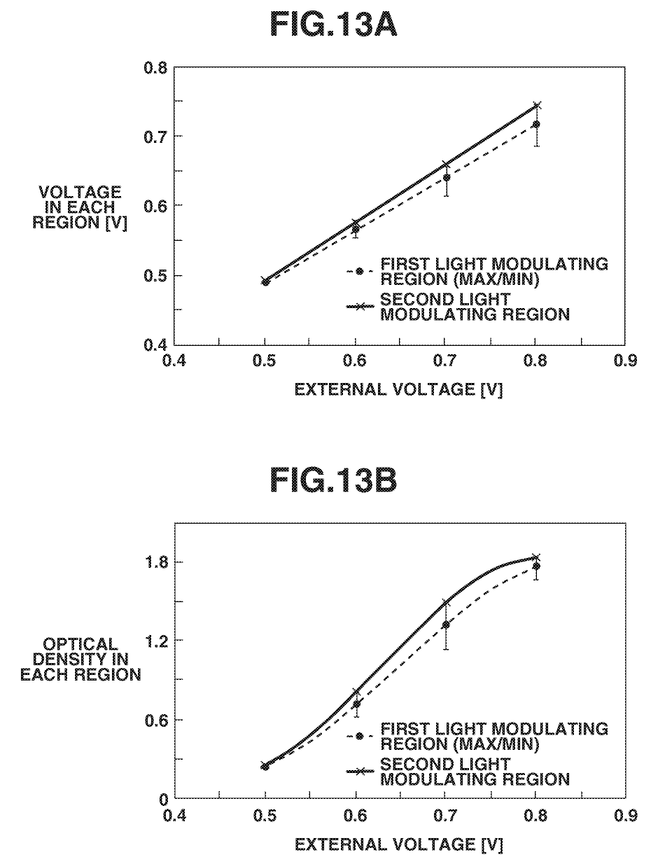

FIG. 13A is a chart on which average voltage in each of the first and second light modulating regions is plotted with respect to external voltage. Since series resistance was not formed in the second light modulating region, it can be seen that a potential in the second light modulating region was approximately equal to a maximum potential in the first light modulating region. At this time, a variation in potential in the first light modulating region was 8.4% when the external voltage was 0.8 V. Meanwhile, a gap between an average potential in the first light modulating region and an average potential in the second light modulating region increased with an increase of external voltage, and was approximately 4.0% at 0.8 V.

FIG. 13B is a chart on which average optical density in each of the first and second light modulating regions is plotted with respect to external voltage. A variation in optical density in the first light modulating region was the largest to be 33% at around 0.65 V. Meanwhile, the difference between average optical density in the first light modulating region and average optical density in the second light modulating region was approximately 15% at a maximum.

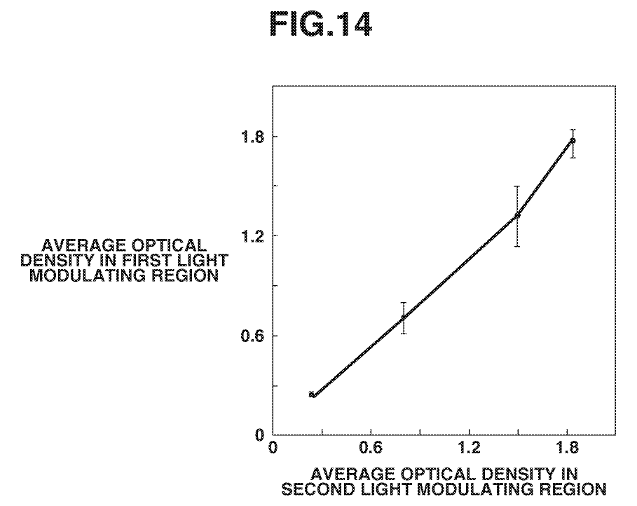

FIG. 14 illustrates a correlation between the average optical density in the first light modulating region and the average optical density in the second light modulating region, and it can be found that a gap is large at density of 1.2 (equivalent to about 4 stops). When such a gap in optical density occurs between the first and second light modulating regions, more strict detection accuracy is required in measurement of transmittance in the second light modulating region. Specifically, for example, when an attempt is made to control transmittance of 1/8 stops in the first light modulating region at optical density of 1.5 to 1.8 (equivalent to about 5 to 6 stops), detection accuracy of about 1/10 stops is required in the second light modulating region. Thus, it is necessary to provide the second light modulating region with series resistance to set transmittance at a transmittance target value in the first light modulating region or transmittance slightly higher than the transmittance target value.

The present disclosure enables strict transmittance control of the EC element. As a result, it is possible to provide the EC element, the lens unit, and the imaging apparatus that are excellent in exposure accuracy and color reproducibility.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-066837, filed April 15, 2025, which is hereby incorporated by reference herein in its entirety.

What is claimed is:

1. An electrochromic element comprising:
a first electrode substrate;
a second electrode substrate;
an electrochromic layer containing at least one electrochromic compound disposed between the first electrode substrate and the second electrode substrate; and
a first light modulating region and a second light modulating region that do not overlap with each other in orthogonal projection on a principal surface of each of the first and second electrode substrates and that are driven by an identical voltage signal,
wherein the electrochromic element is configured to detect transmittance in the second light modulating region to control transmittance in the first light modulating region, and
wherein the electrochromic element is configured to provide the second light modulating region with series resistance formed by an electrode cutout pattern included in each of the first and second electrode substrates to control voltage applied to the electrochromic layer in the second light modulating region.

2. The electrochromic element according to claim 1, wherein an average potential in the second light modulating region is within ±2% of an average potential in the first light modulating region.

3. The electrochromic element according to claim 1, wherein a diagonal distance in the first light modulating region exceeds 28 mm, and a diagonal distance in the second light modulating region is 28 mm or less.

4. The electrochromic element according to claim 1, wherein, out of the first light modulating region and the second light modulating region, only the second light modulating region includes a transmittance detection unit configured to detect transmittance.

5. The electrochromic element according to claim 1, wherein the electrochromic layer in the first light modulating region and the electrochromic layer in the second light modulating region are separated from each other.

6. The electrochromic element according to claim 1,
wherein the first light modulating region and the second light modulating region each include:
the first electrode;
the second electrode; and
the electrochromic layer disposed between the first electrode and the second electrode, and
wherein a distance between the first electrode and the second electrode is equal in the first light modulating region and the second light modulating region.

7. The electrochromic element according to claim 1, wherein the electrochromic layer contains an anodic electrochromic compound and a cathodic electrochromic compound.

8. A lens unit comprising:
an imaging optical system including a plurality of lenses; and
an optical filter configured to control a light quantity of light that has passed through the imaging optical system,
wherein the optical filter includes the electrochromic element according to claim 1.

9. An imaging apparatus comprising:
an imaging optical system including a plurality of lenses;
an image pickup element configured to receive light that has passed through the imaging optical system; and
an optical filter that is disposed between the imaging optical system and the image pickup element,
wherein the optical filter includes the electrochromic element according to claim 1.
